(19) United States
(12) Patent Application Publication
(10) Pub. No.: US 2026/0340155 A1
(43) Pub. Date: Oct. 29, 2026

(54) METHOD, APPARATUS, DEVICE, AND MEDIUM FOR PROCESSING IMAGE DATA

(71) Applicant: Beijing Zitiao Network Technology Co., Ltd., Beijing (CN)

(72) Inventors: Jinyang ZHENG, Beijing (CN); Jiayi TAO, Beijing (CN); Wen WEN, Beijing (CN)

(21) Appl. No.: 19/661,335

(22) Filed: Apr. 28, 2026

(30) Foreign Application Priority Data
Apr. 28, 2025 (CN) 202510551528.6

(51) Int. Cl. G06F 21/60; G06T 7/70; G06T 7/90; G06T 11/10

(52) U.S. Cl. CPC G06F 21/602; G06T 7/70; G06T 7/90; G06T 11/10; G06T 2207/10024; G06T 2210/36

(57) ABSTRACT

There are provided a method, an apparatus, a device, and a medium for processing image data. In a method for encrypting image data, a template image for encrypting the image data is determined. A plurality of encrypted pixels of a plurality of pixels in the image data are determined according to the plurality of pixels and the template image. Encrypted image data of the image data is determined based on the plurality of encrypted pixels. Further, a corresponding method for encrypting image data is provided. With the implementations of the present disclosure, the color of each pixel in the encrypted image data has been changed, so that the information in the original image data may be hidden, thereby improving the security of the image data.

### CROSS-REFERENCE

This application claims priority to Chinese Patent Application No. 202510551528.6, filed on Apr. 28, 2025, and entitled “METHOD, APPARATUS, DEVICE, AND MEDIUM FOR PROCESSING IMAGE DATA”, the disclosures of which are incorporated herein by reference in its entirety.

### TECHNICAL FIELD

Implementations of the present disclosure generally relate to image data processing, and in particular, to a method, an apparatus, a device, and a computer-readable storage medium for encrypting and decrypting image data.

### BACKGROUND

With the development of network technologies, image data may be transmitted between a plurality of devices. In order to ensure the security of the image data, various encryption and decryption technical solutions have been developed. However, with an increasing demand for image data transmission, a processing device needs to use a large number of resources to perform encryption and/or decryption processes. Further, with a development trend toward device miniaturization, limited resources in a small terminal device cannot support a complex encryption and/or decryption process. At this point, it is desired to propose a technical solution that processes image data in a simpler and more effective manner.

### SUMMARY

In a first aspect of the present disclosure, a method of encrypting image data is provided. In the method, a template image for encrypting the image data is determined. A plurality of encrypted pixels of a plurality of pixels in the image data are determined according to the plurality of pixels and the template image. Encrypted image data of the image data is determined based on the plurality of encrypted pixels.

In a second aspect of the present disclosure, an apparatus for encrypting image data is provided. The apparatus includes: a first template determination module configured to determine a template image for encrypting the image data; a first pixel determination module configured to determine a plurality of encrypted pixels of a plurality of pixels in the image data according to the plurality of pixels and the template image; and a first image determination module configured to determine encrypted image data of the image data based on the plurality of encrypted pixels.

In a third aspect of the present disclosure, an electronic device is provided. The electronic device includes: at least one processor; and at least one memory, the at least one memory is coupled to the at least one processor and stores instructions executable by the at least one processor, the instructions, when executed by the at least one processor, cause the electronic device to perform the method of the first aspect.

In a fourth aspect of the present disclosure, a computer-readable storage medium is provided. The computer-readable storage medium stores a computer program, the computer program, when executed by a processor, causes the processor to implement the method of the first aspect.

In a fifth aspect of the present disclosure, a computer program product is provided. The computer program product includes a computer program, the computer program, when executed by a processor, implements the method of the first aspect.

In a sixth aspect of the present disclosure, a method of decrypting image data is provided. In the method, a template image for decrypting the image data is determined. A plurality of decrypted pixels of a plurality of pixels in the image data are determined according to the plurality of pixels and the template image. Decrypted image data of the image data is determined based on the plurality of decrypted pixels.

In a seventh aspect of the present disclosure, an apparatus for decrypting image data is provided. The apparatus includes: a second template determination module configured to determine a template image for decrypting the image data; a second pixel determination module configured to determine a plurality of decrypted pixels of a plurality of pixels in the image data according to the plurality of pixels and the template image; and a second image determination module configured to determine decrypted image data of the image data based on the plurality of decrypted pixels.

In an eighth aspect of the present disclosure, an electronic device is provided. The electronic device includes: at least one processor; and at least one memory, the at least one memory is coupled to the at least one processor and stores instructions executable by the at least one processor, the instructions, when executed by the at least one processor, cause the electronic device to perform the method of the sixth aspect.

In a ninth aspect of the present disclosure, a computer-readable storage medium is provided. The computer-readable storage medium stores a computer program, the computer program, when executed by a processor, causes the processor to implement the method of the sixth aspect.

In a tenth aspect of the present disclosure, a computer program product is provided. The computer program product includes a computer program, the computer program, when executed by a processor, implements the method of the sixth aspect.

It should be understood that content described in the content part of the present disclosure is neither intended to identify key or essential features of the implementations of the present disclosure, nor is used to limit the scope of the present disclosure. Other features of the present disclosure will be readily envisaged through the following description.

### BRIEF DESCRIPTION OF THE DRAWINGS

The above and other features, advantages, and aspects of the implementations of the present disclosure will become more apparent in the following, in conjunction with the drawings and with reference to the following detailed description. In the drawings, the same or similar reference symbols refer to the same or similar elements, where:

FIG. 1 illustrates a block diagram of an application environment according to an implementation of the present disclosure;

FIG. 2 illustrates a block diagram of encrypting image data according to some implementations of the present disclosure;

FIG. 3 illustrates a block diagram of determining a template image according to some implementations of the present disclosure;

FIG. 4 illustrates a block diagram of adjusting a template image according to some implementations of the present disclosure;

FIG. 5 illustrates a block diagram of image data according to some implementations of the present disclosure;

FIG. 6 illustrates a block diagram of image data according to some implementations of the present disclosure;

FIG. 7 illustrates a block diagram of generating an encrypted image sequence according to some implementations of the present disclosure;

FIG. 8 illustrates a block diagram of decrypting image data according to some implementations of the present disclosure;

FIG. 9A illustrates a flowchart of a method of encrypting image data according to some implementations of the present disclosure;

FIG. 9B illustrates a block diagram of an apparatus for encrypting image data according to some implementations of the present disclosure;

FIG. 10A illustrates a flowchart of a method of decrypting image data according to some implementations of the present disclosure;

FIG. 10B illustrates a block diagram of an apparatus for decrypting image data according to some implementations of the present disclosure; and

FIG. 11 illustrates a block diagram of a device capable of implementing a plurality of implementations of the present disclosure.

### DETAILED DESCRIPTION OF EMBODIMENTS

The implementations of the present disclosure will be described in more detail below with reference to the drawings. Although some implementations of the present disclosure are shown in the drawings, it should be understood that the present disclosure may be implemented in various forms, and should not be interpreted as being limited to the implementations set forth herein. On the contrary, these implementations are provided for a more thorough and complete understanding of the present disclosure. It should be understood that the drawings and the implementations of the present disclosure are only for illustrative purposes, and are not intended to limit the protection scope of the present disclosure.

In the description of the implementations of the present disclosure, the term “include/comprise” and similar terms should be understood as open-ended inclusions, that is, “include/comprise but not limited to”. The term “based on” should be understood as “at least partially based on”. The term “an implementation” or “the implementation” should be understood as “at least one implementation”. The term “some implementations” should be understood as “at least some implementations”. Other explicit and implicit definitions may also be included below. As used herein, the term “model” may represent an association between various data. For example, the above association may be obtained based on various technical solutions currently known and/or to be developed in the future.

It may be understood that the data involved in the technical solution (including but not limited to the data itself, acquisition or use of the data) should comply with requirements of corresponding laws, regulations, and related provisions.

It may be understood that before using the technical solutions disclosed in various embodiments of the present disclosure, the user should be informed of the type, range of use, use scenarios, etc., of personal information involved in the present disclosure in an appropriate manner and obtain the authorization of the user according to relevant laws and regulations.

For example, in response to receiving an active request from a user, prompt information is sent to the user to clearly notify the user that the requested operation will require access to and use of the user's personal information. In this way, the user may independently choose, according to the prompt information, whether to provide the personal information to software or hardware, such as an electronic device, an application, a server, or a storage medium, that performs operations of the technical solutions of the present disclosure.

As an optional but non-restrictive implementation, in response to receiving the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It may be understood that the above process of notifying and obtaining the authorization of the user is only illustrative, and does not constitute a limitation to the implementations of the present disclosure. Other manners that satisfy the relevant laws and regulations may also be applied to the implementations of the present disclosure.

The term “in response to” used herein represents a state that a corresponding event occurs or a condition is satisfied. It will be understood that an execution timing of a subsequent action performed in response to the event or the condition is not necessarily strongly correlated with a time when the event occurs or the condition is established. For example, in some cases, the subsequent action may be performed immediately when the event occurs or the condition is established; while in other cases, the subsequent action may be performed after a period of time has elapsed since the event occurred or the condition was established.

### Example Environment

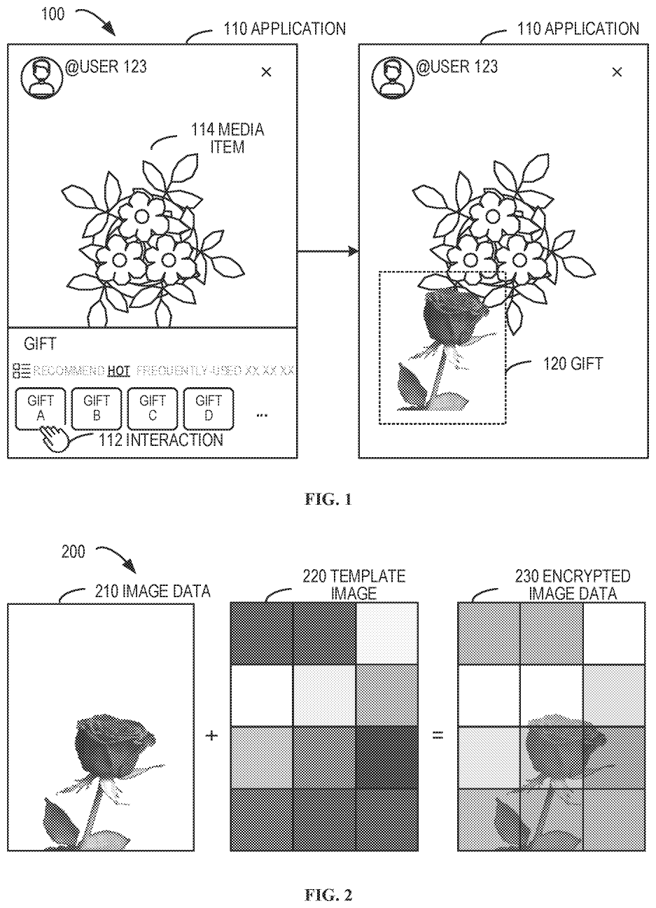

With the development of network technologies, image data may be transmitted between a plurality of devices. An application environment is described with reference to FIG. 1 according to some implementations of the present disclosure, where FIG. 1 illustrates a block diagram 100 of an application environment according to an implementation of the present disclosure. As shown in FIG. 1, an application 110 may receive a media item 114 from, for example, a server device or other devices. The media item 114 may have various formats, including, for example, images, videos, audios, texts, rich media data, and so on. The application 110 may provide a “gift” interface to allow a user to send a gift to a provider of the media item 114. In response to receiving an interaction 112 from the user, a corresponding gift 120 may be presented in the application 110. Generally speaking, the gift may be represented by image data, and may include formats such as images, animated images, and/or videos and the like. Developers may spend a great deal of time and effort in producing image data such as gifts, and malicious users may steal the image data and use it maliciously.

In order to ensure the security of the image data, various encryption and decryption technical solutions have been developed. For example, an encrypted resource package of the image data may be generated. For example, the resource package may be encrypted with a password to protect access permission to the image data. However, once the password is leaked, the content of the resource package will be fully exposed. In another example, an encryption algorithm may be used to protect the image data. Similarly, a leakage of the key or a reverse cracking of the algorithm will lead to a leakage of the image data. In yet another example, an encryption algorithm may be embedded in the encoding process of the image data, which leads to poor player compatibility of the image data, and frame-by-frame encryption and decryption will occupy a large number of computing resources and make it difficult to support high resolution.

However, with an increasing demand for image data transmission, a processing device needs to use a large number of resources to perform encryption and/or decryption processes. Further, with a development trend toward device miniaturization, limited resources in a small terminal device cannot support a complex encryption and/or decryption process. At this point, it is desired to propose a technical solution that processes image data in a simpler and more effective manner.

### Overview of Managing Image Data

In order to at least partially solve the deficiencies in the prior art, according to an implementation of the present disclosure, a method of processing image data is proposed. An overview is described with reference to FIG. 2 according to an implementation of the present disclosure, where FIG. 2 illustrates a block diagram 200 of encrypting image data according to some implementations of the present disclosure. As shown in FIG. 2, image data 210 may be acquired, which may be unencrypted original image data. Further, a template image 230 for encrypting the image data 210 may be determined. Herein, the template image 230 may be, for example, a color card including a plurality of color blocks; alternatively and/or additionally, the template image 230 may be any other image data. A plurality of encrypted pixels of a plurality of pixels in the image data 210 may be determined according to the plurality of pixels and the template image 220. For example, colors of corresponding pixels in the image data 210 and the template image 220 may be superimposed to determine an encrypted pixel. Further, encrypted image data 230 of the image data 210 may be determined based on the plurality of encrypted pixels.

According to some implementations of the present disclosure, a decryption operation may be performed corresponding to the reverse processing described above. Specifically, the influence of the template image 220 may be removed from the encrypted image data 230 to restore the original image data 210.

With some implementations of the present disclosure, the color of each pixel in the encrypted image data 230 has been changed, so that the information in the original image data may be hidden, thereby improving the security of the image data. Further, using the template image to encrypt the original image data does not lead to excessive resource overhead, and is therefore particularly suitable for performing encryption and/or decryption processes at devices with limited processing resources.

### Detailed Process of Managing Image Data

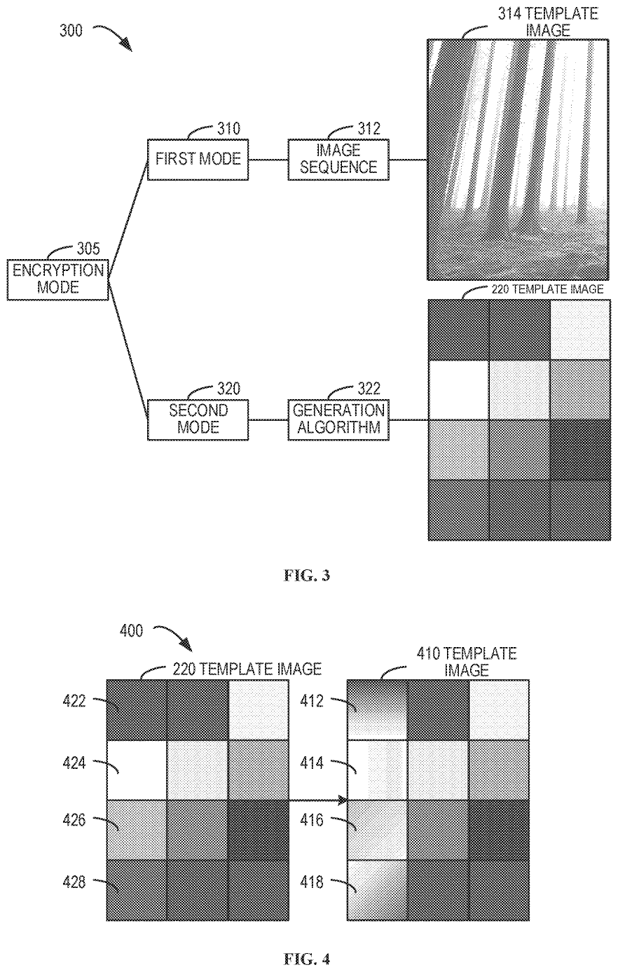

The overview according to some implementations of the present disclosure has been described, and in the following, more information about the encryption process will be provided. According to some implementations of the present disclosure, the template image may be determined in a plurality of manners. For example, the template image may be determined from a predetermined image sequence. More details are described with reference to FIG. 3, which illustrates a block diagram 300 of determining a template image according to some implementations of the present disclosure. As shown in FIG. 3, a plurality of encryption modes 305 may be specified, for example, a first mode 310 may specify to select a template image 314 from an image sequence 312. Herein, the image sequence 312 may include one or more images, and in an example, it may be specified to use a default template image to perform encryption and decryption processes. Specifically, it may be specified to use a user-related image as the template image, for example, use a user avatar, a background image, or other images as the template image. In this way, it is possible to avoid transmitting the template image to a client device that performs the decryption process, thereby reducing the data transmission load.

Alternatively and/or additionally, the image sequence 312 may include a plurality of images. In this case, the image sequence 312 may be used as a codebook in the encryption and decryption processes, so that the template image may be determined in a simpler and more effective manner. Continuing with the above example, the same image sequence (for example, including template images 1 to M) may be stored at the client device running the application and at the server device of the application. During the transmission of a certain image data, it may be specified to use the i^{th} template image to encrypt the image data. In this case, in the decryption process, the i^{th} template image may be directly used. In this way, there is no need to transmit the template image, so that the related network overhead involved in transmitting the template image may be reduced.

According to some implementations of the present disclosure, a second mode 320 may specify that a generation algorithm 322 is used to generate the template image 220. Specifically, in the process of determining the template image, a position of at least one image block in the template image may be determined based on a resolution of the image data; a color of the at least one image block may be determined using an encryption function; and the template image may be acquired based on the position and the color of the at least one image block. The image block may be determined according to a predetermined size, for example, W*H, where W represents a width of the image block and H represents a height of the image block. Alternatively and/or additionally, the image data may be divided into N image blocks according to the resolution of the image data, and so on. The color of the image block may be determined using the encryption function, for example, the color of each image block may be randomly determined, or the color of each image block may be specified according to a predetermined order. Further, the color may be filled for each image block one by one according to the position of the image block to obtain the template image. With some implementations of the present disclosure, the template image may be generated in a simpler and more effective manner. Further, since each pixel in the image block has the same color, the template image generated in this way has a higher compression ratio and is convenient for storage and transmission.

According to some implementations of the present disclosure, a size of the image block may be determined based on a complexity of content in the image data. For image data with complex content, the image block may be set to a smaller size. In this way, more noise data may be added to the image data, thereby improving the security of the image data. For image data with relatively simple content, the image block may be set to a larger size. In this way, the complexity of generating the template image may be reduced, thereby reducing resource overhead.

With some implementations of the present disclosure, a color of a pixel in the template image may be adjusted using a predetermined offset function. Specifically, the color of each pixel in the block may be further adjusted to further increase the difficulty of cracking the template image. More details are described with reference to FIG. 4, which illustrates a block diagram 400 of adjusting a template image according to some implementations of the present disclosure. As shown in FIG. 4, a gradual color adjustment manner may be specified to adjust the template image 220 to a template image 410. One or more image blocks in the template image 220 may be adjusted. For example, a block 422 may be adjusted to a block 412 in a top-down gradient manner, a block 424 may be adjusted to a block 414 in a left-to-right gradient manner, a block 426 may be adjusted to a block 416 in a gradient manner from the upper left to the lower right, a block 428 may be adjusted to a block 418 in a gradient manner from the lower right to the upper left, and so on. A specific formula for calculating the gradient color of each pixel may be specified, for example, determining the color of the pixel based on an interpolation manner, and so on. With some implementations of the present disclosure, data security may be further improved.

According to some implementations of the present disclosure, the image data may include at least one image, in which case the plurality of pixels are a plurality of pixels in a target image in the at least one image. More details are described with reference to FIG. 5, which illustrates a block diagram 500 of image data according to some implementations of the present disclosure. As shown in FIG. 5, the image data may include image data 210, . . . , image data 510, . . . , image data 512, etc., and present a visual effect of a rose from small to large. Each target image may be processed in a similar manner, specifically, each image may be encrypted using the same or different template data, and each encrypted image may be processed according to a predetermined video encoding process to generate an encrypted video.

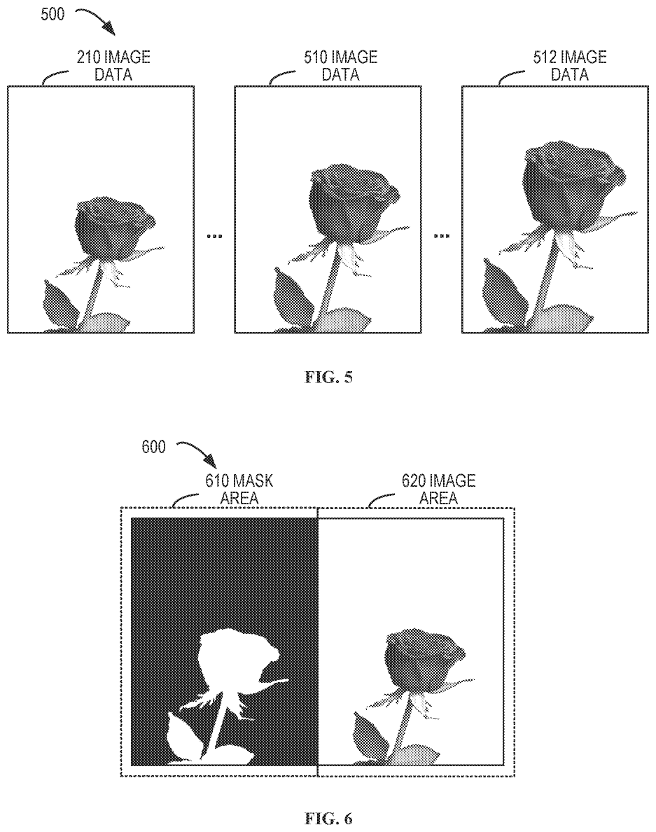

According to some implementations of the present disclosure, all the pixels in the image data may be encrypted. Alternatively and/or additionally, part of the pixels in the image data may be encrypted. For example, in a scenario where the image data is a gift with a transparent effect, the image data may include a mask that specifies a transparent area. Since the mask part only includes the outline of the gift and does not include too many details, in this case, only the image area including the specific gift content may be encrypted to reduce the resource overhead of the encryption process. More details are described with reference to FIG. 6, which illustrates a block diagram 600 of image data according to some implementations of the present disclosure. As shown in FIG. 6, the target image includes a mask area 610 and an image area 620, in which case the template image may be used to encrypt the image area 620. With some implementations of the present disclosure, only a part of the area of the target image is encrypted, which may reduce the amount of data to be processed, thereby reducing the overhead of computing resources related to the encryption process.

It should be understood that, although only an example of using one template image to encrypt the image data is shown above, alternatively and/or additionally, a plurality of template images may be used to encrypt the image data. In this case, a plurality of template images may be provided, and the plurality of template images may be used to encrypt a single image. For example, the template images 314 and 220 shown in FIG. 3 may be used to encrypt different areas of the image (for example, the template image 314 may be used to encrypt the upper half of the image, and the template image 220 may be used to encrypt the lower half of the image, and so on). In the decryption process, each template image may be used to decrypt each part. Alternatively and/or additionally, different template images may be used to encrypt different image frames in the video. In the decryption process, respective template images may be used to decrypt each image frame.

According to some implementations of the present disclosure, in the process of determining the plurality of encrypted pixels of the plurality of pixels, a target template image in the at least one template image may be determined; and the plurality of encrypted pixels of the plurality of pixels in the target image may be determined based on the plurality of pixels in the target image and the target template image. In this case, the template image may be represented in a video format, and an image frame in a video may be encrypted using a template frame in a template video. For example, the i^{th} frame in the template video may be used to encrypt the i^{th} frame in a to-be-processed video. Alternatively and/or additionally, a mapping relationship between two image frames may be specified, for example, for the i^{th} frame in the to-be-processed video frame, a mapping function m(i) may be used to determine a position of a template frame. The mapping function m(i) may be transmitted to the client device to determine the template frame for decryption in the decryption process. With some implementations of the present disclosure, the video data may be encrypted in a more secure manner, thereby further improving data security.

According to some implementations of the present disclosure, configuration information for presenting the image data may be acquired; and the encrypted image data and the configuration information may be sent to a client device. Specifically, in the environment of the “gift” interface described above, the configuration information may represent parameters for playing a gift video, for example, information such as access permission and presentation position of the gift animation. With some implementations of the present disclosure, the image encryption technology may be applied to the specific environment of the gift video, thereby improving the security of the gift animation.

According to some implementations of the present disclosure, a specific manner of acquiring the template image may be sent to the client device. For example, the template image may be directly sent to the client device. A data package may be generated using the template image and the encrypted image data, and the data package may be sent to the client device. For another example, the template image may be encrypted first, and the encrypted template image may be sent to the client device. Alternatively and/or additionally, an address for acquiring the template image, an access password, and so on may be sent to the client device. In this way, it may be ensured that the client device may acquire the template image and then use the template image to perform the decryption process.

According to some implementations of the present disclosure, a resolution of the template image may match a resolution of the image data. For example, the template image and the image data may have the same resolution. In this case, in the process of determining the encrypted pixel, for a pixel

$${p}_{ij}^{1}$$

located at (i, j) in the image data, a pixel

$${p}_{ij}^{2}$$

located at (i, j) in the template image may be used to determine the encrypted pixel

$${p}_{ij}^{3} .$$

With some implementations of the present disclosure, the color of the encrypted pixel may be determined in a simple and effective manner, and the resource overhead of the encryption process may be simplified.

Specifically, a predetermined function ƒ( ) may be used to determine the encrypted pixel. In this case, the encrypted pixel may be represented as

$${p}_{ij}^{3} = f ( {p}_{ij}^{1} , {p}_{ij}^{2} ) .$$

A specific expression of the function ƒ( ) may be specified, for example, the function may be represented as an average of a sum of two pixels; in another example, the function may be represented as a modulus of the sum of two pixels; in yet another example, the function may be represented as a modulus of a difference between two pixels, and so on. It should be understood that the above functions are only illustrative, and the function may be determined based on any manner as long as the color of the original pixel may be uniquely restored based on an inverse function of the function in the decryption process.

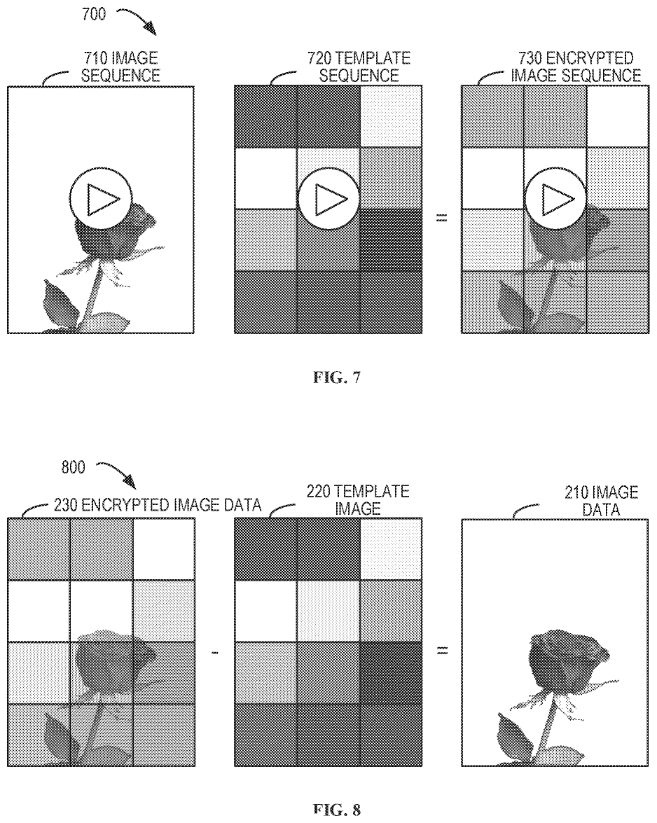

According to some implementations of the present disclosure, in a case where the image is an image sequence, each image in the image sequence may be encrypted in the manner described above, and more details are described with reference to FIG. 7. FIG. 7 illustrates a block diagram 700 of generating an encrypted image sequence according to some implementations of the present disclosure. As shown in FIG. 7, an image sequence 710 and a template sequence 720 may be acquired, and the template sequence 720 may include template images respectively used to encrypt respective images in the image sequence 710. An encrypted image sequence 730 may be generated based on the image sequence 710 and the template sequence 720.

The specific steps of the encryption process have been described above, and the decryption process may be performed in the reverse steps of the encryption process, which may be performed at the client device. The decryption process is described with reference to FIG. 8, which illustrates a block diagram 800 of decrypting image data according to some implementations of the present disclosure, and FIG. 8 is a reverse process corresponding to the encryption process in FIG. 2. Herein, the decryption process is an inverse process of the encryption process, and the reverse process of the encryption process may be used to restore the original image data. According to some implementations of the present disclosure, the template image 220 for decrypting the image data may be determined, and herein the image data is encrypted image data (for example, the encrypted image data 230). A plurality of decrypted pixels of a plurality of pixels in the image data may be determined according to the plurality of pixels and the template image 220. Decrypted image data of the image data may be determined based on the plurality of decrypted pixels. The decrypted image data here may be decrypted image data (for example, the original image data 210) restored from the encrypted image data.

According to some implementations of the present disclosure, in the decryption process, a resolution of the template image matches a resolution of the image data. In this way, respective pixels in the template image correspond to respective pixels in the image data, and thus the computational complexity of the decryption process may be simplified.

According to some implementations of the present disclosure, in the process of determining the template image, the template image may be determined from a predetermined image sequence. In this way, the image sequence may be used as a codebook in the encryption and decryption processes, so that the template image may be determined in a simpler and more effective manner.

According to some implementations of the present disclosure, the template image may include at least one image block, and a color of the at least one image block is determined using an encryption function. In this way, the template image may be generated in a simpler and more effective manner. Further, since each pixel in the image block has the same color, the template image generated in this way has a higher compression ratio and is convenient for storage and transmission.

According to some implementations of the present disclosure, the image data may include at least one image, and the plurality of pixels are a plurality of pixels in a target image in the at least one image. In this way, image data in different formats may be decrypted, for example, a single image may be decrypted, or a plurality of images in an image sequence may be decrypted in a similar manner.

According to some implementations of the present disclosure, the target image may include a mask area and an image area, and the template image is used to decrypt the image area. In this way, only a part of the area of the target image (that is, the image area involving higher data security) may be decrypted, which may reduce the amount of data to be processed, thereby reducing the overhead of computing resources related to the decryption process.

According to some implementations of the present disclosure, the template image may include at least one template image, and in the process of determining the plurality of decrypted pixels of the plurality of pixels, a target template image in the at least one template image may be determined; and the plurality of decrypted pixels of the plurality of pixels in the target image may be determined based on the plurality of pixels in the target image and the target template image. In this way, the original image data may be restored according to the mapping relationship between the image frame and the template frame specified in the encryption process.

According to some implementations of the present disclosure, a color of a pixel in the template image may be adjusted using a predetermined offset function. In this way, the original color of the template image may be restored in a reverse process of the offset function in the encryption process, thereby further improving the security in the encryption/decryption process.

According to some implementations of the present disclosure, configuration information for presenting the image data may be acquired; and the decrypted image data may be presented at a client device based on the configuration information. In this way, the image decryption technology may be applied to the specific presentation environment of the image data, thereby further improving security.

According to some implementations of the present disclosure, determining the template image includes: extracting the template image from a data package associated with the image data. For example, a server may send a data package (for example, including the image data and the template image) in an encrypted format to the client device, and the template image may be extracted from the data package, and then the template image may be used to perform the decryption process. In this way, the security of data transmission may be improved.

### Example Processes and Apparatuses

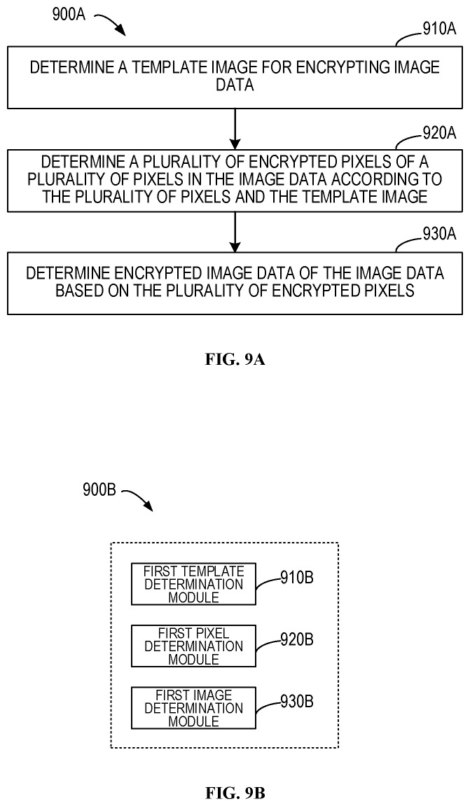

FIG. 9A illustrates a flowchart of a method 900A of encrypting image data according to some implementations of the present disclosure. At a block 910A, a template image for encrypting image data is determined. At a block 920A, a plurality of encrypted pixels of a plurality of pixels in the image data are determined according to the plurality of pixels and the template image. At a block 930A, encrypted image data of the image data is determined based on the plurality of encrypted pixels.

According to some implementations of the present disclosure, a resolution of the template image matches a resolution of the image data.

According to some implementations of the present disclosure, determining the template image includes: determining the template image from a predetermined image sequence.

According to some implementations of the present disclosure, determining the template image includes: determining a position of at least one image block in the template image based on a resolution of the image data; determining a color of the at least one image block using an encryption function; and acquiring the template image based on the position and the color of the at least one image block.

According to some implementations of the present disclosure, the image data includes at least one image, and the plurality of pixels are a plurality of pixels in a target image in the at least one image.

According to some implementations of the present disclosure, the target image includes a mask area and an image area, and the template image is used to encrypt the image area.

According to some implementations of the present disclosure, the template image includes at least one template image, and determining the plurality of encrypted pixels of the plurality of pixels includes: determining a target template image in the at least one template image; and determining the plurality of encrypted pixels of the plurality of pixels in the target image based on the plurality of pixels in the target image and the target template image.

According to some implementations of the present disclosure, the method further includes: adjusting a color of a pixel in the template image using a predetermined offset function.

According to some implementations of the present disclosure, the method further includes: acquiring configuration information for presenting the image data; and sending the encrypted image data and the configuration information to a client device.

According to some implementations of the present disclosure, the method further includes: sending an encrypted template image to the client device.

FIG. 9B illustrates a block diagram of an apparatus 900B for encrypting image data according to some implementations of the present disclosure. The apparatus 900B includes: a first template determination module 910B configured to determine a template image for encrypting image data; a first pixel determination module 920B configured to determine a plurality of encrypted pixels of a plurality of pixels in the image data according to the plurality of pixels and the template image; and a first image determination module 930B configured to determine encrypted image data of the image data based on the plurality of encrypted pixels.

According to some implementations of the present disclosure, a resolution of the template image matches a resolution of the image data.

According to some implementations of the present disclosure, the first template determination module 910B is further configured to: determine the template image from a predetermined image sequence.

According to some implementations of the present disclosure, the first template determination module 910B is further configured to: determine a position of at least one image block in the template image based on a resolution of the image data; determine a color of the at least one image block using an encryption function; and acquire the template image based on the position and the color of the at least one image block.

According to some implementations of the present disclosure, the image data includes at least one image, and the plurality of pixels are a plurality of pixels in a target image in the at least one image.

According to some implementations of the present disclosure, the target image includes a mask area and an image area, and the template image is used to encrypt the image area.

According to some implementations of the present disclosure, the template image includes at least one template image, and the first pixel determination module is further configured to: determine a target template image in the at least one template image; and determine the plurality of encrypted pixels of the plurality of pixels in the target image based on the plurality of pixels in the target image and the target template image.

According to some implementations of the present disclosure, the apparatus 900B further includes: a first processing module configured to adjust a color of a pixel in the template image using a predetermined offset function.

According to some implementations of the present disclosure, the apparatus 900B further includes: a first processing module configured to acquire configuration information for presenting the image data; and send the encrypted image data and the configuration information to a client device.

According to some implementations of the present disclosure, the apparatus 900B further includes: a first processing module configured to send an encrypted template image to the client device.

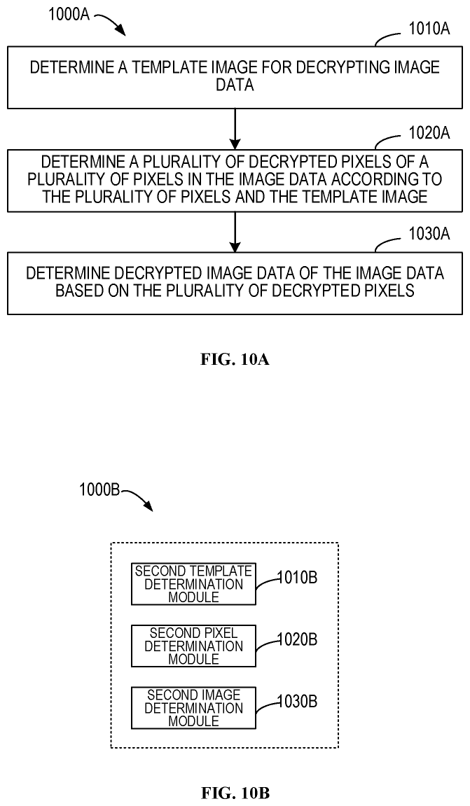

FIG. 10A illustrates a flowchart of a method 1000A of decrypting image data according to some implementations of the present disclosure. At a block 1010A, a template image for decrypting image data is determined. At a block 1020A, a plurality of decrypted pixels of a plurality of pixels in the image data are determined according to the plurality of pixels and the template image. At a block 1030A, decrypted image data of the image data is determined based on the plurality of decrypted pixels.

According to some implementations of the present disclosure, a resolution of the template image matches a resolution of the image data.

According to some implementations of the present disclosure, determining the template image includes: determining the template image from a predetermined image sequence.

According to some implementations of the present disclosure, the template image includes at least one image block, and a color of the at least one image block is determined using an encryption function.

According to some implementations of the present disclosure, the image data includes at least one image, and the plurality of pixels are a plurality of pixels in a target image in the at least one image.

According to some implementations of the present disclosure, the target image includes a mask area and an image area, and the template image is used to decrypt the image area.

According to some implementations of the present disclosure, the template image includes at least one template image, and determining the plurality of decrypted pixels of the plurality of pixels includes: determining a target template image in the at least one template image; and determining the plurality of decrypted pixels of the plurality of pixels in the target image based on the plurality of pixels in the target image and the target template image.

According to some implementations of the present disclosure, the method 1000A further includes: adjusting a color of a pixel in the template image using a predetermined offset function.

According to some implementations of the present disclosure, the method 1000A further includes: acquiring configuration information for presenting the image data; and presenting the decrypted image data at a client device based on the configuration information.

According to some implementations of the present disclosure, determining the template image includes: extracting the template image from a data package associated with the image data.

FIG. 10B illustrates a block diagram of an apparatus 1000B for decrypting image data according to some implementations of the present disclosure. The apparatus 1000B includes: a second template determination module 1010B configured to determine a template image for decrypting image data; a second pixel determination module 1020B configured to determine a plurality of decrypted pixels of a plurality of pixels in the image data according to the plurality of pixels and the template image; and a second image determination module 1030B configured to determine decrypted image data of the image data based on the plurality of decrypted pixels.

According to some implementations of the present disclosure, a resolution of the template image matches a resolution of the image data.

According to some implementations of the present disclosure, the second template determination module 1010B includes: determining the template image from a predetermined image sequence.

According to some implementations of the present disclosure, the template image includes at least one image block, and a color of the at least one image block is determined using an encryption function.

According to some implementations of the present disclosure, the image data includes at least one image, and the plurality of pixels are a plurality of pixels in a target image in the at least one image.

According to some implementations of the present disclosure, the target image includes a mask area and an image area, and the template image is used to decrypt the image area.

According to some implementations of the present disclosure, the template image includes at least one template image, and the pixel determination module 1020B is further configured to: determine a target template image in the at least one template image; and determine the plurality of decrypted pixels of the plurality of pixels in the target image based on the plurality of pixels in the target image and the target template image.

According to some implementations of the present disclosure, the apparatus 1000B further includes: a second processing module configured to adjust a color of a pixel in the template image using a predetermined offset function.

According to some implementations of the present disclosure, the apparatus 1000B further includes: a second processing module configured to: acquire configuration information for presenting the image data; and present the decrypted image data at a client device based on the configuration information.

According to some implementations of the present disclosure, the apparatus 1000B further includes: a second processing module configured to: extract the template image from a data package associated with the image data.

### Example Device

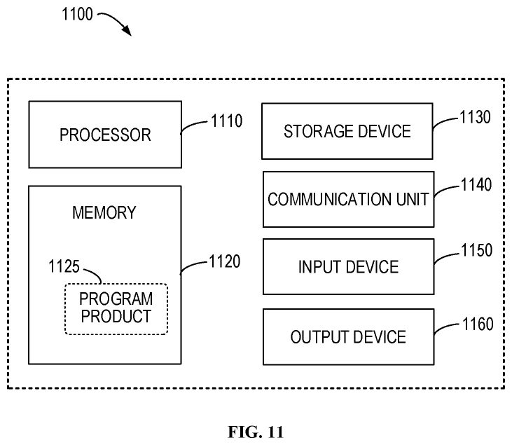

FIG. 11 illustrates a block diagram of a device 1100 capable of implementing a plurality of implementations of the present disclosure. It should be understood that the computing device 1100 shown in FIG. 11 is only illustrative, and should not constitute any limitation on the functions and scope of the implementations described herein. The computing device 1100 shown in FIG. 11 may be used to implement the method described above.

As shown in FIG. 11, the computing device 1100 is in the form of a general-purpose computing device. Components of the computing device 1100 may include, but are not limited to, one or more processors 1110, a memory 1120, a storage device 1130, one or more communication units 1140, one or more input devices 1150, and one or more output devices 1160. The processor 1110 may be an actual or virtual processor, and may perform various processes according to programs stored in the memory 1120. In a multi-processor system, a plurality of processors execute computer executable instructions in parallel to improve the parallel processing capability of the computing device 1100.

The computing device 1100 typically includes a plurality of computer storage medium. Such medium may be any available medium that is accessible to the computing device 1100, including but not limited to volatile and non-volatile medium, removable and non-removable medium. The memory 1120 may be volatile memory (for example, a register, cache, a random access memory (RAM)), a non-volatile memory (for example, a read-only memory (ROM), an electrically erasable programmable read-only memory (EEPROM), a flash memory), or any combination thereof. The storage device 1130 may be any removable or non-removable medium, and may include a machine-readable medium such as a flash drive, a disk, or any other medium, which may be used to store information and/or data (for example, training data for training) and may be accessed within the computing device 1100.

The computing device 1100 may further include additional removable/non-removable, volatile/non-volatile memory medium. Although not shown in FIG. 11, a disk driver for reading from or writing to a removable, non-volatile disk (such as a “floppy disk”), and an optical disk driver for reading from or writing to a removable, non-volatile optical disk may be provided. In these cases, each driver may be connected to a bus (not shown) by one or more data medium interfaces. The memory 1120 may include a computer program product 1125, which has one or more program modules configured to perform various methods or acts of various implementations of the present disclosure.

The communication unit 1140 implements communication with other computing devices through the communication medium. Additionally, the functions of the components of the computing device 1100 may be implemented by a single computing cluster or a plurality of computing machines, which may communicate through communication connections. Therefore, the computing device 1100 may use a logical connection with one or more other servers, a network personal computer (PC), or another network node to operate in a networked environment.

The input device 1150 may be one or more input devices, such as a mouse, a keyboard, a tracking ball, and the like. The output device 1160 may be one or more output devices, such as a display, a speaker, a printer, and the like. The computing device 1100 may further communicate with one or more external devices (not shown) as needed through the communication unit 1140, the external devices such as a storage device, a display device, and the like, communicate with one or more devices that enable a user to interact with the computing device 1100, or communicate with any devices (for example, a network card, a modem, and the like) that enable the computing device 1100 to communicate with one or more other computing devices. Such communication may be performed via input/output (I/O) interfaces (not shown).

According to an implementation of the present disclosure, a computer-readable storage medium is provided, which stores computer executable instructions, and the computer executable instructions are executed by a processor to implement the method described above. According to an implementation of the present disclosure, there is further provided a computer program product, the computer program product is tangibly stored on a non-transitory computer-readable medium and includes computer executable instructions, and the computer executable instructions are executed by a processor to implement the method described above. According to an implementation of the present disclosure, a computer program product is provided, which stores a computer program, and the program, when executed by a processor, implements the method described above.

Various aspects of the present disclosure are described herein with reference to flowcharts and/or block diagrams of methods, apparatuses, devices, and computer program products implemented according to the present disclosure. It should be understood that each block of the flowcharts and/or block diagrams, and combinations of blocks in the flowcharts and/or block diagrams may be implemented by computer-readable program instructions.

These computer-readable program instructions may be provided to a processor of a general-purpose computer, a special-purpose computer, or other programmable data processing apparatus to produce a machine, such that when the instructions are executed by the processor of the computer or other programmable data processing apparatus, an apparatus for implementing a function/act specified in one or more blocks in the flowcharts and/or block diagrams is produced. These computer-readable program instructions may also be stored in a computer-readable storage medium, these instructions cause the computer, the programmable data processing apparatus, and/or other devices to work in a specific manner, and thus, the computer-readable medium storing the instructions includes a manufactured product, which includes instructions for implementing various aspects of the function/act specified in one or more blocks in the flowcharts and/or block diagrams.

The computer-readable program instructions may be loaded onto a computer, another programmable data processing apparatus, or other devices, so that a series of operation steps are performed on the computer, the another programmable data processing apparatus, or other devices to generate a computer-implemented process, such that the instructions executed on the computer, the another programmable data processing apparatus, or other devices implement the function/act specified in one or more blocks in the flowcharts and/or block diagrams.

The flowcharts and block diagrams in the drawings show the possibly implemented architectures, functions, and operations of the system, the method, and the computer program product according to a plurality of implementations of the present disclosure. In this regard, each block in the flowchart or block diagram may represent a module, program segment, or part of an instruction, which includes one or more executable instructions for implementing the specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and the combination of the blocks in the block diagrams and/or flowcharts may be implemented by a special-purpose hardware-based system that performs the specified functions or acts, or may be implemented by a combination of special-purpose hardware and computer instructions.

The implementations of the present disclosure have been described above, and the above description is illustrative, non-exhaustive, and not limited to the disclosed implementations. Without departing from the scope and spirit of the illustrated implementations, many modifications and changes will be apparent to those of ordinary skill in the art. The terms used herein are chosen to best explain the principles of the implementations, the practical applications, or improvements to the technologies in the market, or to enable other those of ordinary skill in the art to understand the implementations disclosed herein.

1. A method of encrypting image data, comprising:
determining a template image for encrypting the image data;
determining a plurality of encrypted pixels of a plurality of pixels in the image data according to the plurality of pixels and the template image; and
determining encrypted image data of the image data based on the plurality of encrypted pixels.

2. The method of claim 1, wherein a resolution of the template image matches a resolution of the image data.

3. The method of claim 1, wherein determining the template image comprises: determining the template image from a predetermined image sequence.

4. The method of claim 1, wherein determining the template image comprises:
determining a position of at least one image block in the template image based on the resolution of the image data;
determining a color of the at least one image block using an encryption function; and
acquiring the template image based on the position and the color of the at least one image block.

5. The method of claim 1, wherein the image data comprises at least one image, and the plurality of pixels are a plurality of pixels in a target image in the at least one image.

6. The method of claim 5, wherein the target image comprises a mask area and an image area, and the template image is used to encrypt the image area.

7. The method of claim 5, wherein the template image comprises at least one template image, and determining the plurality of encrypted pixels of the plurality of pixels comprises:
determining a target template image in the at least one template image; and
determining the plurality of encrypted pixels of the plurality of pixels in the target image based on the plurality of pixels in the target image and the target template image.

8. The method of claim 1, further comprising: adjusting a color of a pixel in the template image using a predetermined offset function.

9. The method of claim 1, further comprising:
acquiring configuration information for presenting the image data; and
sending the encrypted image data and the configuration information to a client device.

10. The method of claim 9, further comprising: sending an encrypted template image to the client device.

11. A method of decrypting image data, comprising:
determining a template image for decrypting image data;
determining a plurality of decrypted pixels of a plurality of pixels in the image data according to the plurality of pixels and the template image; and
determining decrypted image data of the image data based on the plurality of decrypted pixels.

12. The method of claim 11, wherein a resolution of the template image matches a resolution of the image data.

13. The method of claim 11, wherein determining the template image comprises: determining the template image from a predetermined image sequence.

14. The method of claim 11, wherein the template image comprises at least one image block, and a color of the at least one image block is determined using an encryption function.

15. The method of claim 11, wherein the image data comprises at least one image, and the plurality of pixels are a plurality of pixels in a target image in the at least one image.

16. The method of claim 15, wherein the target image comprises a mask area and an image area, and the template image is used to decrypt the image area.

17. The method of claim 15, wherein the template image comprises at least one template image, and determining the plurality of decrypted pixels of the plurality of pixels comprises:
determining a target template image in the at least one template image; and
determining the plurality of decrypted pixels of the plurality of pixels in the target image based on the plurality of pixels in the target image and the target template image.

18. The method of claim 11, further comprising: adjusting a color of a pixel in the template image using a predetermined offset function.

19. The method of claim 11, further comprising:
acquiring configuration information for presenting the image data; and
presenting the decrypted image data at a client device based on the configuration information,
wherein determining the template image comprises: extracting the template image from a data package associated with the image data.

20. An electronic device, comprising:
at least one processor; and
at least one memory, the at least one memory is coupled to the at least one processor and stores instructions executable by the at least one processor, the instructions, when executed by the at least one processor, causes the electronic device to perform the method of encrypting image data, comprising:
determining a template image for encrypting the image data;
determining a plurality of encrypted pixels of a plurality of pixels in the image data according to the plurality of pixels and the template image; and
determining encrypted image data of the image data based on the plurality of encrypted pixels.
